(19) United States
(12) Patent Application Publication
(10) Pub. No.: US 2005/0176356 A1
(43) Pub. Date: Aug. 11, 2005

(54) Method for processing a crustaceans

(76) Inventors: Cyrill G Gallant, Souris (CA); Lily Hong, Edmonton (CA); Richard Ablett, Charlottetown (CA); Paul Wueser, Rosemere (CA)

Correspondence Address: BORDEN LADNER GERVAIS LLP, WORLD EXCHANGE PLAZA, 100 QUEEN STREET SUITE 1100, OTTAWA, ON, K1P 1J9, CA

(21) Appl. No.: 10/498,559

(22) PCT Filed: Dec. 12, 2001
(86) PCT No.: PCT/CA01/01776

(51) Int. Cl. A22C 29/02

(52) U.S. Cl. 452/8

(57) ABSTRACT

Methods for processing of killed crustaceans are provided herein. In one such method, an essential step of processing a killed crustacean include cutting the thorax of the killed crustacean. The anterior section of the crustacean is vacuum eviscerated through the cut thorax. The removal of the visceral contents of the crustacean is completed by the sole step of back-flushing the anterior section of the crustacean with water. the posterior section of the crustacean is vacuum eviscerated. The removal of the intestinal contents of the crustacean is completed by the sole step of back-flushing the posterior section of the crustacean with water. This provides an intact crustacean having intact raw edible crustacean meat in situ, in which the intact raw edible crustacean meat is not subject to visceral staining and/or the concentration of heavy-metal contaminants therein.

### (i) TECHNICAL FIELD TO WHICH THE INVENTION RELATES

The present invention relates to procedures for the processing of hard shelled crustaceans, e.g., clawed lobsters of the Homaridae family, and crab, e.g., Snow crab, Maryland Blue crab, Alaska King crab, Dungeness crab, Irish crab (Cancer pagurus) and Jonah crab (Cancer borealis) and including species of the genera Panulirus, Jasus and Chelonectes and to lobster-like crustaceans, including some types of prawn, Nephrops norwegicus and freshwater crayfish species, as well as the processing of hard-to-process clawless Spiny lobster and Rock lobster species of temperate and tropical origin, as well as to the processing of hard-to-process Northern Stone Crab (Lithodes maja), Porcupine Crab (Neolithodes grimaldii), and Green Crab. The present invention also provides crustaceans which are either intact, whole, such crustaceans containing intact, loosened, raw crustacean meat, or stuffed, intact, whole, such crustaceans containing both intact, loosened, raw crustacean meat and stuffing.

### (ii) BACKGROUND ART

A traditional method for processing and packaging easy-to-process clawed lobsters of the Homaridae family consisted of cooking them whole, either by steam exposure or by hot water immersion, cooling the product and sealing them in plastic bags containing brine solution with subsequent freezing to render the lobster embedded in ice. Inherent in this traditional lobster frozen-in-brine product, a substantial degree of visceral staining of the edible meat components within the upper tail region was encountered. This was attributed, in part, to migration and rupture of the visceral hepatopancreatic fraction and intestinal tract contents during the preparative cooking procedure. Also inherent to this traditional lobster product were residual heavy-metal contaminants, which were predominately-located in the visceral fraction and which underwent migration to the edible body meat fraction as a result of cooking procedures.

Another traditional method of processing intact lobsters consisted of freezing cooked lobsters, which were wrapped individually in wax paper in a master-box. Another common method involved the removal of the intact tail section of lobsters with subsequent individual quick-freezing, and packaging the tails through alignment into a box. In such products, the raw lobster material either in an intact form, or as tail sections, was prone to problems of breakage due to the brittle nature of their shell material. Particularly, such problems were encountered during distribution and transportation procedures.

The extraction of meat from the body of hard-shelled crustaceans in which the meat was very strongly attached to the shell, e.g., all species of crab, crayfish, lobster, and rock shrimp, as opposed to soft-shelled crustaceans, e.g., all shrimp species, other than rock shrimp, has proved to be very difficult, time consuming and expensive. Present day practices for obtaining the edible portions from such crustaceans, e.g., all species of lobster, crab, crayfish, rock shrimp, and the like, generally involved a variety of mechanical, electrical and heat-treatments which included subjecting the crustaceans to a sawing action on the shells, a high or low electrical voltage through the shells, treatment with direct flame, immersion in boiling water or various chemical treatments, or treatment with steam at atmospheric pressure or under high pressures in closed vessels. A myriad of other procedures were also known which involved combinations of some or all of the foregoing methods. While some of the procedures had various degrees of success, most of the prior known procedures required hand labour to treat the individual fresh crustaceans in order to remove the edible flesh.

Pre-treatment of the crustaceans by chemicals, the use of certain cooking conditions, the use of machines which squeezed the meat out, or which cored and centrifuged the meat out, or in which air or water blasted the meat out, or which froze and exploded the meat out, had also been proposed and advanced with varying degrees of success.

In the current art and industry of producing meat from the various species of crab, it is now common practice to prepare the cooked crab body for removal of the meat by processing the body through a machine which removed the claws, flippers, walking legs and carapace, and then brushed and flushed the visceral cavity. Further machine processing of the prepared body could successfully produce marketable regular mat, but could not remove the backfin lump meat which was considered to be the most valuable product of the crab and which, to date, must be removed by hand picking. An improvement to that processing procedure involved preparing the crab for removal of the lump meat after cooking and removing of the carapace. That procedure involved cutting the side mounds of the body along planes which were disposed at equal acute angles to the bottom shell of the crab and converged to meet along the intersection of the bottom shell and the middle bony ridge, and were outside the inner walls of the collar bones. This exposed the two lump meats, after which a hand tool was inserted into each lump cavity on either side of the lump, and was then compressed and withdrawn, bringing the lump meat with it.

There are many patents which are directed to the processing of such shellfish. Non-limiting examples include the following patents:

U.S. Pat. No. 2,155,308, patented Apr. 18, 1939, by Sterling G. Harris and assigned to The Blue Channel Corporation; U.S. Pat. No. 2,501,655, patented Mar. 28, 1950, by W. M. Altenburg; U.S. Pat. No. 2,858,223, patented Oct. 28, 1958, by Sterling G. Harris, and assigned to The Blue Channel Corporation; U.S. Pat. No. 2,978,334, patented Apr. 4, 1961, by Lapeyre, and assigned to The Peelers Company; U.S. Pat. No. 3,022,175, patented Feb. 20, 1962 by L. A. Wakefield; U.S. Pat. No. 3,159,992, patented Jun. 9, 1964, by L. C. Fredrickson; U.S. Pat. No. 3,156,949, patented Nov. 17, 1964, by J. P. Moncure; U.S. Pat. No. 3,253,299, patented May 31, 1966, by S. G. Harris, assigned to The Blue Channel Corporation; U.S. Pat. No. 3,471,894, patented Oct. 14, 1965 by E. W. Tasker, assigned to Cape Ann Marine Research Company Inc.; U.S. Pat. No. 3,513,071 patented May 19, 1970, by Gottlieb Bernhard Fehmerling; Japanese Patent No. 46-10898; U.S. Pat. No. 3,705,040, patented Dec. 5, 1972, by Peter W. Bynagte, and assigned to Westgate-California Foods, Inc.; U.S. Pat. No. 4,053,964, patented Oct. 18, 1977, by J. E. Rutledge; and U.S. Pat. No. 4,340,613, patented Jul. 20, 1982, by Michael P. Moore.

Other patents taught the production of seafood pastes. Non-limiting examples include the following: U.S. Pat. No. 4,588,601, patented May 13, 1986, by T. Maruyama et al, and assigned to Kibun Company Limited; U.S. Pat. No. 4,816,278, patented Mar. 28, 1989, by Sasamoto et al, and assigned to The Japanese Research and Development Association for Extrusion Cooking, Nippon Suisan Kabushiki Kaisha, Taiyo Fishery Co. Ltd., Kabushiki Kaisha Kobe Seikosho, Ajikan Col Ltd., and Kougyo Co. Ltd.; U.S. Pat. No. 4,820,529, patented Apr. 11, 1989, by Y. Uchida et al, and assigned to Asahi Denka Kogyo Kabushiki Kaisha; and U.S. Pat. No. 5,560,954, issued Oct. 1, 1996, to Gabriel Elbaz.

The present applicant has provided a teaching of the processing of crustaceans in the following patent literature:

In U.S. Pat. No. 6,159,520, patented Dec. 12, 2000, there is a teaching of vacuum evisceration of lobsters in the following terms.

The method involved killing of live lobsters by hot-water blanch immersion, under temperature conditions ranging between 50° C. and 95° C. for a duration of between 40 seconds to 80 seconds, with immediate transfer to cold water conditions under temperature conditions ranging between 0° C. to 10° C. for a duration of between 2 minutes to 10 minutes. Lobsters, so-treated, were then subjected to vacuum evisceration of the anterior visceral region using a vacuum aspirator nozzle of between 10 cm to 16 cm in length with a diameter of between 5 mm to 10 mm inserted into the oral cavity. A back-flushing pipe attached to the vacuum nozzle supplied a dilute solution of lactic acid in a concentration range of 5 mg/L to 20 mg/L (w/w) as a bacteriostatic agent. The vacuum was applied in the range of 15 inches to 25 inches of Hg (i.e., 50.84×10⁴ dynes/cm² to 84.75×10⁴ dynes/cm²) and the visceral contents are removed in a period of time ranging between 5 seconds to 15 seconds. Following this procedure, a second vacuum aspirating nozzle with a length ranging between 5 cm to 15 cm and a diameter of between 1 mm to 5 mm was inserted into the anal orifice, to effect vacuum cleaning, and concurrently back-flush irrigation with a dilute solution of lactic acid in a concentration range of 5 mg/L to 20 mg/L (w/w) as a bacteriostatic agent. The latter procedure was preferably accomplished within a period of between 5 seconds and 20 seconds.

In U.S. patent application Ser. No. 09/354,585 filed 16 Jul. 1999, procedures were provided for the optimization of the utilization of crustaceans, e.g., whole lobsters, through the inclusion of under-utilized components. One procedure involved firstly, initiating the detachment of the raw edible deep-shoulder myotomal meat from deep-shoulder cartilaginous skeleton attachment. This could be accomplished either by immersing the head-shell in a solution of protease enzymes, or subjecting the head-shell to at least one freeze-thaw cycle. Then, the so-treated head-shell was subjected to vacuum aspiration to remove, and to recover, the raw meat fraction.

A patent which is believed to be relevant to the present crustacean processing invention is U.S. Pat. No. 3,773,962, patented Nov. 20, 1973, by Trelease et al, and assigned to A. Swift & Company. This patent disclosed a method which included cleaning of the stomach and hind-gut of lobster by the use of vacuum evisceration and/or high velocity water flushing and/or manual gut removal to remove the contents of the stomach and visceral cavity, then cooking the lobster, and finally freezing it.

However, none of these conventional methods, and in particular, the three-specifically-recited patents above, provided a procedure for separating intact crustacean shell from intact whole raw crustacean meat, and to process hard-to-process crustaceans to provide intact raw crustacean meat while also overcoming the limitations of the prior art in substantially avoiding visceral staining and substantially avoiding the concentration of heavy metal contaminants in the raw crustacean meat.

### (iii) DISCLOSURE OF THE INVENTION

The present invention provides a first method for processing a killed crustacean comprising cutting the thorax of a killed crustacean, vacuum eviscerating the anterior section of the crustacean through the cut thorax, completing the removal of the contents of the anterior section of the crustacean by the sole step of back flushing the anterior section of the crustacean with water, vacuum eviscerating the posterior section of the crustacean, completing the removal of the posterior visceral and intestinal contents of the crustacean by the sole step of back-flushing the posterior section of the crustacean with water, thereby providing an intact crustacean having intact raw edible crustacean meat in situ, in which the intact raw edible crustacean meat is not subject to visceral staining and/or the concentration of heavy-metal contaminants therein.

The advantageous effects of this first method of this invention are that, by this method, an intact crustacean is provided in which the intact raw edible crustacean meat is retained in situ in the shell of the crustacean and in which the intact raw edible crustacean meat is not subject to visceral staining and/or the concentration of heavy-metal contaminants therein.

The present invention also provides a second method for processing a killed crustacean comprising cutting the thorax of the killed crustacean, vacuum eviscerating the anterior sections of the crustacean through the cut thorax, completing the removal of the contents of the anterior section of the crustacean by the sole step of back flushing the anterior section of the crustacean with water, vacuum eviscerating the posterior section of the crustacean, completing the removal of the posterior visceral and intestinal contents of the crustacean by the sole step of back-flushing the anterior and posterior section of the crustacean with water, initiating the detachment of intact raw edible crustacean meat from an intact shell of the crustacean by the step of subjecting the intact shell to at least one freeze-thaw cycle, retaining the detached intact raw edible crustacean meat in situ within the intact shell, thereby providing an intact crustacean having detached intact raw edible crustacean meat in situ, in which the detached intact raw edible crustacean meat is not subject to visceral staining and/or the concentration of heavy-metal contaminants therein.

The advantageous effects of this second method of this invention are that, by this method, an intact crustacean is provided in which the detached intact raw edible crustacean meat is retained in the shell of the crustacean in situ, and in which the detached intact raw edible crustacean meat is not subject to visceral staining and/or the concentration of heavy-metal contaminants therein.

The present invention also provides a third method for processing a killed crustacean comprising cutting the thorax of the killed crustacean, vacuum eviscerating the anterior section of the crustacean through the cut thorax, completing the removal of the contents of the anterior section of the crustacean by the sole step of back flushing the anterior section of the crustacean with water, vacuum eviscerating the posterior section of the crustacean, completing the removal of the contents of the posterior visceral and intestinal contents of the crustacean by the sole step of back-flushing the posterior section of the crustacean with water, filling the anterior visceral cavity of the crustacean with a stuffing, thereby providing an intact stuffed crustacean having intact raw edible crustacean meat in situ which is in integuous contact with the stuffing within the crustacean shell, the intact raw edible crustacean meat and the stuffing not being subject to visceral staining and/or the concentration of heavy-metal contaminants therein.

The advantageous effects of this third method of this invention are that, by this method, an intact stuffed crustacean is provided in which the intact raw crustacan meat is retained in the shell of the crustacean in situ and is in contact with the stuffing within the crustacean shell, and in which the intact raw edible crustacean meat is not subject to visceral staining and/or the concentration of heavy metal contaminants therein.

The present invention also provides a fourth method for processing a killed crustacean comprising cutting the thorax of the killed crustacean, vacuum eviscerating the anterior section of the crustacean through the cut thorax, completing the removal of the contents of the anterior section of the crustacean by the sole step of back flushing the anterior section of the crustacean with water, vacuum eviscerating the posterior section of the crustacean, completing the removal of the posterior visceral and intestinal contents of the crustacean by the sole step of back-flushing the posterior section of the crustacean with water, initiating the detachment of intact raw edible crustacean meat from an intact shell of the crustacean by the step of subjecting the intact shell to at least one freeze-thaw cycle, retaining the detached intact raw edible crustacean meat in situ within the intact shell, and filling the interior visceral cavity of the crustacean with a stuffing, thereby providing an intact stuffed crustacean having intact raw detached edible crustacean meat in situ which is in contact with the stuffing within the crustacean shell, the intact raw detached edible crustacean meat and the stuffing not being subject to visceral staining and/or the concentration of heavy-metal contaminants therein.

The advantageous effects of this fourth method of this invention are that, by this method, an intact stuffed crustacean is provided in which the intact raw detached crustacean meat is retained in the shell of the crustacean in situ and is in contact with the stuffing within the crustacean shell, and in which the intact raw detached edible crustacean meat is not subject to visceral staining and/or concentration of heavy metal contaminants therein.

The present invention also provides a fifth method of processing live crustacean comprising killing the crustacean by removing the cap therefrom, removing the tail from the crustacean and subjecting claws/knuckles and the body/carapace to at least one freeze/thaw cycle so that detached intact raw crustacean meat is retained in situ in the shell of the claws/knuckles and the body/carapace.

Embodiments of the first, second, third and fourth methods of this invention include the following: the vacuum eviscerating is achieved under 50.85×10⁴ dynes/cm² to 84.75×10⁴ dynes/cm²; the back-flushing is with a dilute aqueous solution of lactic acid, where preferably the lactic acid is at a concentration of 5 to 20 ml/L (w/w), thereby to provide bacteriostatic properties to the eviscerated crustacean; the crustacean has been killed by blanching at a temperature of 70° C. to 100° C. for a time, respectively, of 60 seconds to 40 seconds; the intact crustacean containing the intact raw adhered or detached crustacean meat is frozen and then packaged; the intact crustacean containing the intact raw adhered or detached crustacean meat is chilled; the method includes the steps of cooking the intact, whole crustacean containing intact adhered or detached crustacean meat at 100° C., for a sufficient period of time to achieve an internal temperature of at least 75° C., and rapidly cooling to effect rapid temperature removal; preferably the cooking step is by steam-cooking; preferably the cooling step is by spray irrigation; the crustacean containing the cooked intact adhered or detached crustacean meat may be frozen and then packaged; the crustacean containing the cooked intact adhered or detached crustacean meat may be chilled and then packaged; the raw stuffing is introduced into an interior visceral cavity of a previously-eviscerated crustacean by oral intubation and subsequent vibration to effect removal of residual air, thereby to achieve effective filling of the interior visceral cavity and effecting integuous contact between the raw stuffing and the contour of the inner shell surface and the region of abutment of the internal and interior abdominal facets of the adhered or detached crustacean meat of the previously-eviscerated crustacean; the cooked stuffed crustacean containing the cooked intact adhered or detached crustacean meat, as well as the cooked stuffing, is frozen and is then packaged; the cooked stuffed crustacean containing the cooked intact adhered or detached crustacean meat, as well as the cooked stuffing, is chilled and then is packaged; the freezing is carried out at a temperature of 10° C. to minus 20° C., followed by thawing until a temperature of 4° C. to 12° C. is reached, e.g., wherein the thawing is accomplished in cold water, or in a cold dilute solution of brine; the thawing is accomplished at a temperature of 1° C. to 10° C. for a period of time between 1 minute and 10 minutes, e.g., wherein the thawing is accomplished in a period of time of 3 minutes to 8 minutes; wherein the claws/knuckles are subjected to at least one freeze/thaw cycle as described above, the crustacean shell is removed from the crustacean meat, and the crustacean meat is then frozen and packaged; the legs are cut-off from the body, the legs are cooked, the cooked legs are subjected to crushing pressure by passage between two rollers to crush the shell, the cooked crustacean leg meat is recovered from the crushed crustacean shell, and the recovered cooked crustacean leg meat is then frozen and packaged; crustacean legs containing raw crustacean leg meat are removed from the body of the crustacean, the crustacean body/carapace containing raw crustacean meat is degilled, the degilled crustacean body/carapace containing raw crustacean leg meat is shelled and the raw crustacean meat from the shelled crustacean body/carapace is saved.

In all these embodiments, the crustacean may be Homaridae lobster; the crustacean may be Spiny lobster; the crustacean may be crab of any species, e.g., Lithodes maja, or Neolithodes grimaldii, or Cancer pagurus, or Cancer borealis.

A fifth embodiment of this invention provides an intact crustacean in which the intact raw adhered or detached crustacean meat, is retained in the shell of the crustacean in situ, the visceral and intestinal contents of the crustacean having been removed by vacuum evisceration, firstly through a removed thorax followed by back flushing, and in which the intact raw adhered or detached crustacean meat thereby is not subject to visceral staining and/or the concentration of heavy-metal contaminants therein.

The advantageous effect of this fifth embodiment of this invention is that an eviscerated crustacean is provided in which the intact raw adhered or detached crustacean meat is not subject to visceral staining and/or is not subject to the concentration of heavy-metal contaminants therein.

A sixth embodiment of this invention provides an intact stuffed crustacean in which intact raw adhered or detached crustacean meat is retained in the shell of the crustacean in situ, the visceral and intestinal contents of the crustacean having been removed by vacuum evisceration, firstly through a removed thorax, followed by back flushing, the eviscerated crustacean having a filling therein in integuous contact with the intact raw crustacean meat and with the interior of the shell of the crustacean, the intact raw adhered or detached crustacean meat thereby not being subject to visceral staining and/or the concentration of heavy-metal contaminants therein, and the stuffing thereby not having any “off-flavour”.

The advantageous effects of this sixth embodiment of this invention are that a stuffed eviscerated crustacean is provided in which the intact raw adhered or detached crustacean meat is not subject to visceral staining and/or the concentration of heavy-metal contaminants therein and in which the stuffing is not subject to “off-flavours”.

Other embodiments of the fifth and sixth embodiments of this invention provide the following: an intact stuffed cooked crustacean in cooked form, which had been cooked at 100° C. for a sufficient period of time to achieve an internal temperature of at least 75° C., had been rapidly cooled to effect rapid temperature removal, and had been frozen to provide a frozen stuffed, intact, cooked whole crustacean; an intact, stuffed, cooked crustacean had been cooked by steam-cooking; an intact, stuffed, cooked crustacean had been cooked by spray irrigation; the raw stuffing had been introduced into an anterior visceral cavity of a previously-eviscerated crustacean by oral intubation and had been subsequently vibrated to effect removal of residual air, thereby achieving effective filling of the anterior visceral cavity and effecting integuous contact between the raw stuffing and the contour of the inner shell surface and the region of abutment of the internal and interior abdominal facet of the adhered or detached crustacean meat of the previously-eviscerated crustacean.

Still other embodiments of the fifth and sixth embodiments of this invention include having the vacuum evisceration achieved under 50.85×10⁴ dynes/cm² to 84.75×10⁴ dynes/cm²; having the back-flushing carried out with a dilute aqueous solution of lactic acid, thereby providing bacteriostatic properties to the eviscerated crustacean, preferably where the back flushing had been achieved with lactic acid at a concentration of 5 to 20 ml/L (w/w); having the freezing carried out at a temperature of minus 10° C. to minus 20° C., followed by thawing until a temperature of 4° C. to 12° C. is reached, preferably where the thawing had been accomplished in cold water, more preferably, where the thawing had been accomplished in a cold dilute solution of brine; accomplishing the thawing at a temperature of 1° C. to 10° C. for a period of time between 1 minute and 10 minutes, preferably accomplishing the thawing in a period of time of 3 minutes to 8 minutes; an intact stuffed cooked crustacean in cooked form, which had been cooked at a temperature of 100° C. for a sufficient period of time to achieve an internal temperature of at least 75° C., had been rapidly cooled to effect rapid temperature removal, and had been frozen to provide a frozen stuffed, intact, cooked whole crustacean, preferably one which had been cooked by steam-cooking, more preferably one which had been cooked by spray irrigation; an intact, stuffed, cooked crustacean, in which the raw stuffing had been introduced into an anterior visceral cavity of a previously-eviscerated crustacean by oral intubation and had been subsequently vibrated to effect removal of residual air, thereby to achieve effective filling of the anterior visceral cavity and effecting integuous contact between the raw stuffing and the contour of the inner shell surface and the region of abutment of the internal and interior abdominal facet of the adhered or detached meat of the previously-eviscerated crustacean.

In all these embodiments, the crustacean may be Homaridae lobster, or may be Spiny lobster, or may be a crab of any species, e.g., Lithodes maja, or Neolithodes grimaldii, or Cancer pagurus, or Cancer borealis.

### (iv) BRIEF DESCRIPTION OF THE FIGURES IN THE DRAWINGS

In the accompanying drawings,

FIG. 1 is a flow chart of one traditional prior art manner of processing live lobster according to the prior art for raw lobster tail production;

FIG. 2 is a flow chart of another traditional lobster processing technique of the prior art;

FIG. 3 is a flow chart of a manner of processing lobster according to one embodiment of the present invention, namely, a raw eviscerated lobster process; and

FIG. 4 is a flow chart of a manner of processing lobster according to a second embodiment of the present invention, namely, a raw eviscerated lobster process.

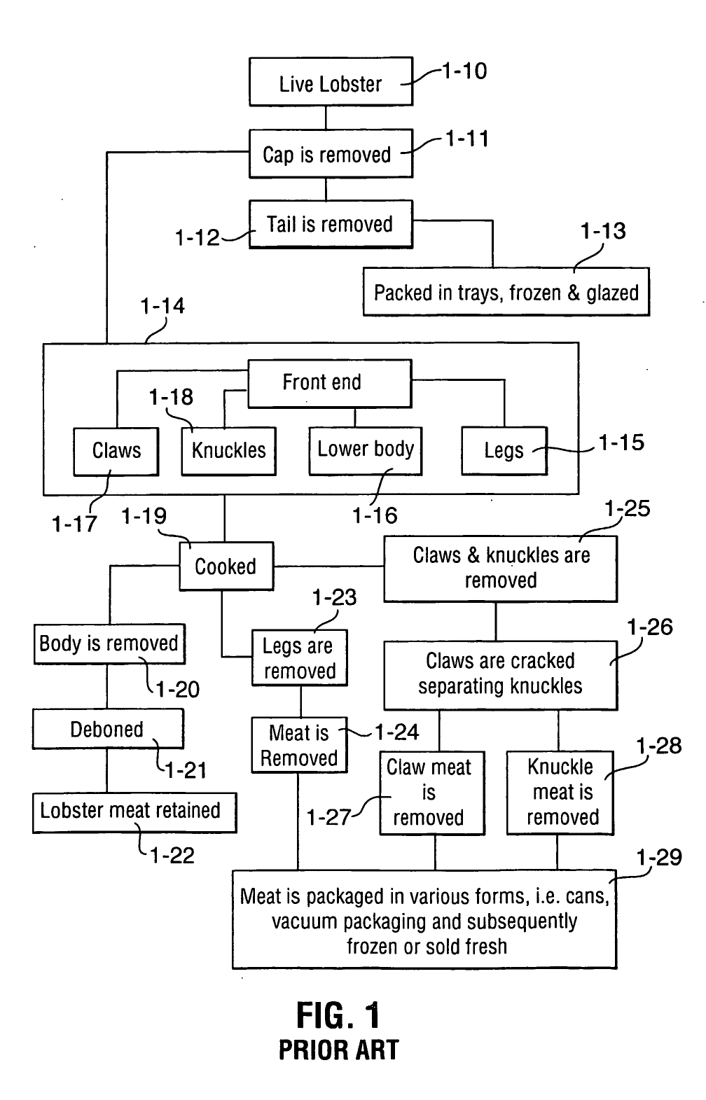

### (a) DESCRIPTION OF FIG. 1

In one embodiment of the prior art, as exemplified in FIG. 1, the live lobster (BLOCK 1-10) is killed by having its cap removed (BLOCK 1-11) by placing a blade under the cap and removing the cap therewith. The tail is then removed from the lobster (BLOCK 1-12). The removed tail may then be packed in cans, trays, frozen and glazed (BLOCK 1-13).

The front end (BLOCK 1-14), which consists of the legs (BLOCK 1-13) lower body (BLOCK 1-16), claws (BLOCK 1-17), and knuckles (BLOCK 1-16) is then cooked (BLOCK 1-19) either in boiling water or by means of steam. The body or purse is then removed from the cooked front end (BLOCK 1-20) and is deboned (BLOCK 1-21). The lobster meat is then retained (BLOCK 1-22).

The legs are then removed from the cooked front end (BLOCK 1-23). The meat of the leg is then removed from the shell (BLOCK 1-24).

The claws and knuckles are then removed from the cooked body (BLOCK 1-25). The claws are then cracked, thereby separating the knuckles (BLOCK 1-26). The claw meat is removed (BLOCK 1-27) and the knuckle meat is removed (BLOCK 1-28). The removed leg meat and/or removed claw meat and/or removed knuckle meat is then packaged in various forms, i.e., cans, or vacuum packaging, and is subsequently either frozen or sold fresh.

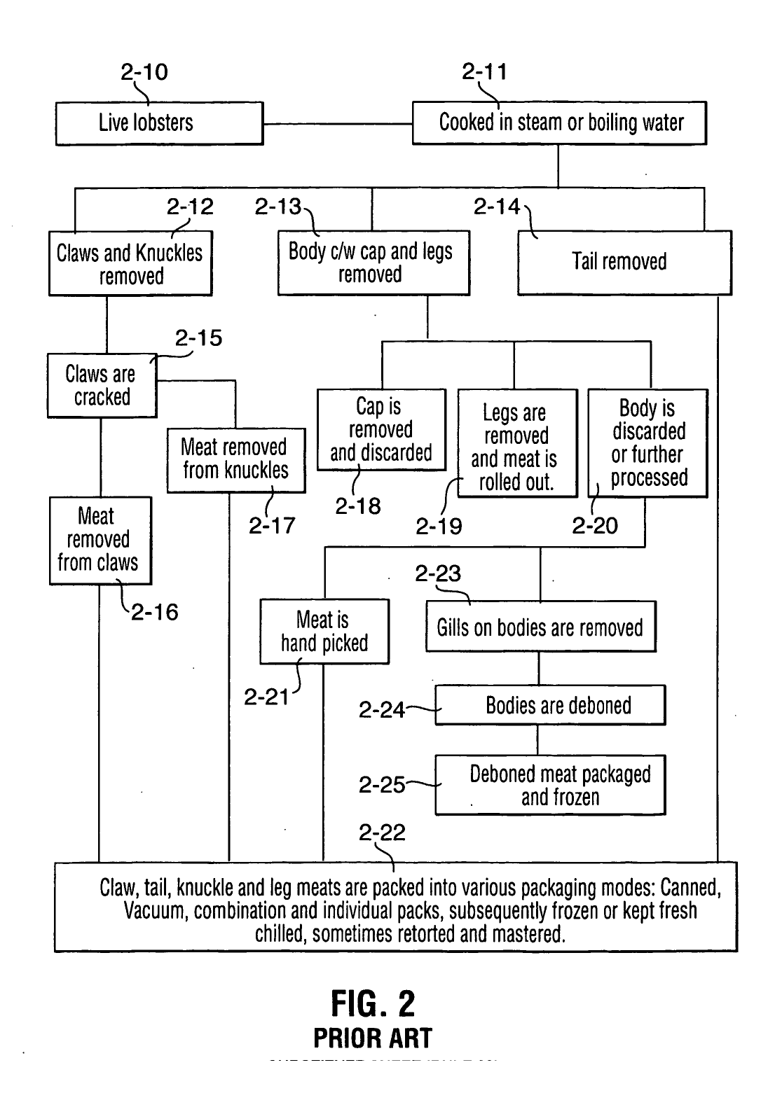

### (b) DESCRIPTION OF FIG. 2

A second embodiment of the prior art will now be described with reference to FIG. 2.

As seen in FIG. 2, the live lobster (BLOCK 2-10) is cooked in steam or boiling water (BLOCK 2-11). The cooked lobster then has its claws and knuckles removed (BLOCK 2-12), its body with caps and legs removed (BLOCK 2-13) and its tail removed (BLOCK 2-14).

From the removed claws and knuckles at BLOCK 2-12, the claws are then cracked (BLOCK 2-15) and the meat removed from the claws (BLOCK 2-16) and from the knuckles (BLOCK 2-17).

From the removed body with the removed cap and legs at BLOCK 2-13, the cap is removed and discarded (BLOCK 2-18). The legs are removed and the meat is rolled out (BLOCK 2-19). The body is either discarded or is further processed (BLOCK 2-20).

If the body is further processed, the meat is hand picked out from the body (BLOCK 2-21). The removed claw, tail and leg may then be packed into various packaging modes, namely: canned, vacuum packed, and combination or individual packs. This may be subsequently frozen or kept fresh, chilled or sometimes retorted and mastered (BLOCK 2-22).

Also, if the body is further processed, the gills on the bodies are removed (BLOCK 2-23). The bodies are then deboned (BLOCK 2-24) and the deboned meat is packaged and frozen (BLOCK 2-25).

### (v) BEST MODE FOR CARRYING OUT THE INVENTION

The method of two embodiments of this invention will now be described with reference to the processing of clawed lobsters of the Homaridae family. However, it is desired to emphasize that, with suitable modifications which will be apparent to those skilled in the art, this method can also be applied to the Rock lobster species of temperate and tropical origin, and including species of the genera Panulirus, Jasus and Chelonectes crab, and to lobster-like crustaceans, including some types of prawn, Nephrops norwegicus and freshwater crayfish species, to Spiny lobster or to hard-to-process species of crab, e.g., Lithodes maja, or Neolithodes grimaldii, or Cancer pagurus, or Cancer borealis.

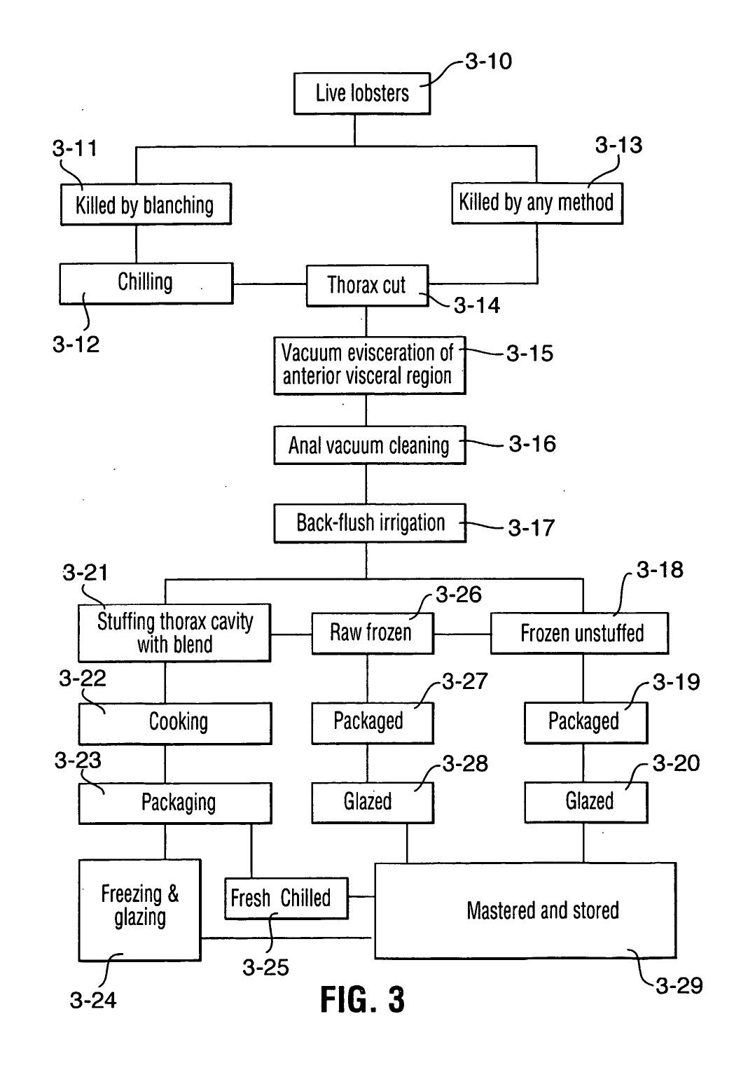

### (c) DESCRIPTION OF FIG. 3

FIG. 3 depicts one embodiment of the present invention for the processing of a raw eviscerated lobster.

As seen in FIG. 3, the live lobster (BLOCK 3-10) is killed by blanching at a temperature ranging from 70° C. to 100° C. for a respective time of 60 seconds to 40 seconds (BLOCK 3-11) and is then chilled (BLOCK 3-12). The lobster may, however, be killed by any other method, including, but not limited to, boiling in water, steam treatment, placing in tepid fresh water, etc. (BLOCK 3-13).

In either case, the thorax is then cut (BLOCK 3-14) from the killed lobster. That lobster is then subjected to vacuum evisceration of the interior visceral region (BLOCK 3-15).

The vacuum evisceration of the present invention consists firstly of removing the thorax, as disclosed above at BLOCK 3-14. Then the lobster so-treated, is subjected to vacuum evisceration of the anterior visceral region (BLOCK 3-15), using a vacuum aspirator nozzle of between 10 cm to 16 cm in length with a diameter of between 5 mm to 10 mm inserted into the oral cavity. The vacuum is applied in the range of 50.85×10⁴ dynes/cm² to 84.75×10⁴ dynes/cm² and the visceral contents are removed in a period of time ranging between 5 seconds to 15 seconds. Following this procedure, a second vacuum aspirating nozzle with a length ranging between 5 cm to 15 cm and a diameter of between 1 mm to 5 mm is inserted into the anal orifice, to effect anal vacuum cleaning (BLOCK 3-16). Completion of the removal of the anterior visceral contents and anal vacuum cleaning is achieved by the sole technique of back-flush irrigation (BLOCK 3-17) (block 314) using a back-flushing pipe which is attached to the vacuum nozzle and which may also optionally supply a dilute solution of a bacteriocide, e.g., lactic acid in a concentration range of 5 mg/L to 20 mg/L (w/w) as a bacteriostatic agent. These vacuum evisceration/and cleaning/back-flush irrigation is preferably accomplished within a period of between 5 seconds and 20 seconds.

The raw lobster product may then be frozen unstuffed (BLOCK 3-18) and packaged in the frozen state (BLOCK 3-19) and glazed (BLOCK 3-20). The thorax cavity may be stuffed with a stuffing blend (BLOCK 3-) The stuffing may be any one of many combinations of fresh meat (e.g., seafood, poultry, beef, veal, goat, etc.), grain (e.g., rice, wild rice, etc.) and vegetable (e.g., carrots, potatoes, legumes, etc.).

The stuffed lobster product is then cooked (BLOCK 3-22). The cooked stuffed lobster product at BLOCK 3-22 may then be packaged (BLOCK 3-23). The packaging may be by freezing and glazing the cooked stuffed lobster product (BLOCK 3-24) or by chilling the cooked stuffed lobster product (BLOCK 3-25).

The stuffed lobster product at BLOCK 3-21 may alternatively be frozen raw (BLOCK 3-20). The frozen raw stuffed lobster product at BLOCK 3-26 may then be packaged (BLOCK 3-27) and glazed (BLOCK 3-28).

The lobster products at BLOCK 3-20, BLOCK 3-28, BLOCK 3-24 and BLOCK 3-25 may then be mastered and stored (BLOCK 3-29).

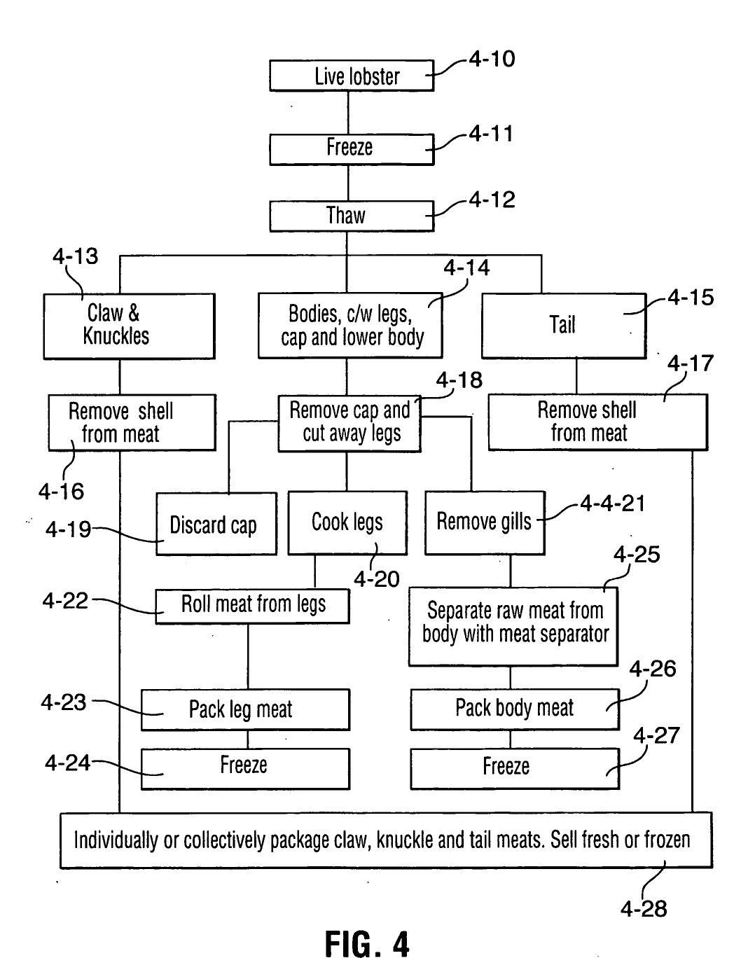

### (d) DESCRIPTION OF FIG. 4

FIG. 4 depicts another embodiment of the present invention as a raw lobster meat process. As seen in FIG. 4, a live lobster (BLOCK 4-10) is subjected to at least one freeze-thaw cycle (BLOCK 4-11) and (BLOCK 4-12).

The freeze-thaw angle at BLOCK 4-11 and BLOCK 4-12 may preferably be carried out as follows:

The freezing may be carried out at a temperature of 10° C. to minus 20° C., followed by thawing until a temperature of 4° C. to minus 12° C. is reached. The thawing may be accomplished in cold water, or in a cold dilute solution of brine. Such thawing may be accomplished at a temperature of 1° C. to 10° C. for a period of time between 11 minute and 10 minutes, and preferably may be accomplished in a period of time of 3 minutes to 8 minutes.

The lobster product resulting from the above-described freeze-thaw cycle is divided into claws and knuckles (BLOCK 4-13) bodies with legs, cap and lower body (BLOCK 4-14) and tail (BLOCK 4-15).

From the claws and knuckles at BLOCK 4-13, the shell is removed from the meat (BLOCK 4-14).

From the tail at (BLOCK 4-15), the shell is removed from the meat (BLOCK 4-17).

From the bodies with legs, cap and lower body at BLOCK 4-14, the cap is removed and the legs are cut away (BLOCK 4-18). The cap is discarded (BLOCK 4-19).

The legs are cooked (BLOCK 4-20). The cooked meat is removed from the legs by passing the legs between two rollers to crush the shell and to roll the meat from the legs (BLOCK 4-22). The leg meat is packed (BLOCK 4-23) and frozen (BLOCK 4-24).

The gills are removed from the bodies (BLOCK 4-21). The raw meat is separated from the body using a meat separator (BLOCK 4-15). The body meat is packed (BLOCK 4-26) and frozen (BLOCK 4-27).

The meat which is removed from the claws and knuckles at BLOCK 4-13 and the meat which is removed from the tail at BLOCK 4-17 may be individually or collectively packaged and sold fresh or frozen (BLOCK 4-28).

### (e) GENERALIZED DESCRIPTION OF THE INVENTION

Advantageously, for cooking the lobster product, very good results have been obtained by placing the raw intact lobster product ventral side uppermost into a process dedicated steam chamber, e.g., the one sold for this purpose by Atlantic Systems Manufacturing Ltd. (Canada), with sufficient duration to achieve an internal temperature within the visceral cavity of between 70° C. to 85° C. This procedure is generally achieved in a time-frame of between 15 minutes to 20 minutes, and serves to cook the intact lobster while still maintaining the integral tail, leg and claw loosened meat sections in an optimal condition. Immediately following attainment of the desired internal temperature, of between 75° C. to 85° C., and to avoid post-cook drying of the delicate intact lobster meat, it has been proven necessary to cool the cooked product rapidly.

The optimal method of cooling the cooked lobster product has been to subject the cooked lobster to hydro-cooling by cold water spray irrigation, directed as a drench to the dorsal surface of lobsters which are positioned with the dorsal surface uppermost. Most efficient results have been obtained through the use of a process-dedicated hydro-cooling device, e.g., the one sold by Atlantic Systems Manufacturing Ltd. (Canada). In such application, optimal results can be obtained through the use of either potable fresh water or sea water, in the temperature range of between 1° C. and 9° C., for a cooling period of between 5 minutes and 10 minutes, then effecting acceptable heat-reduction from within the centre of the lobster to between 20° C. to 30° C. Other procedures involving immersion in ice-water mixes or ice per se can be utilized, but these procedures do not lend themselves to industrial assembly line applications.

The frozen lobster may be packaged in vacuum-sealable pouches under deep vacuum, in the range of 84.75×10⁴ dynes/cm² to 101.7×10⁴ dynes/cm². Optionally, prior to packaging, frozen cooked intact lobster can be bi-sectioned along the longitudinal axis by band-sawing and reconfigured as an intact product prior to vacuum packaging. In terms of the packaging material, optimum shelf-life results are obtained through use of a heavy-duty shrinkable film laminate, e.g., the material sold by Cryovac (Canada). Moreover, the subsequent film-shrinking by heat exposure serves to minimize potential for breakage of appendages and body parts of the lobster, which is a recognized problem due to the brittle shell characteristics of the lobster.

With the above-described preparative methods of this embodiment of this invention, and with the equipment specifically-designed to support the procedures, up to 400 units per hour of finished lobster products can be processed, which is commercially interesting and appealing.

The stuffing is carried out as follows: A stuffing blend is prepared. This stuffing blend may be a blend of meat of any species and/or fish of an species and/or any grain and/or any vegetable. The blending procedure is preferably achieved by a food processor, e.g., the one sold by Mari-tech Ltd. (Canada) until a creamy liquid consistency is achieved. The stuffing blend may be of fish and meat in any proportion, or, meat and vegetable in any proportions or fish and meat and vegetable in any proportions in any other combination. During such blending an edible starch, e.g., the one sold by Nacan Products Limited (USA), may be added to the stuffing blend to ensure its freeze-thaw stability. The fish and/or the meat and/or the vegetables and/or grain stuffing mixture is mixed with the starch.

Ordinarily, the mixing under reduced pressure may be accomplished by agitating in an agitator that can be sealed hermetically, and can provide inside an environment of reduced pressure. The degree of reduced pressure is, e.g., 0 mm to 260 mm Hg. According to this embodiment of the present invention, the mixture may be agitated rapidly at a reduced pressure near vacuum. The mixing may be successfully-accomplished under such reduced pressure, at 260 mm of Hg pressure or less.

Examples of suitable agitators include a mixer, kneader, cutter, and so on which permit adequate agitation, e.g., one where all, mixer, etc., can be utilized at one time. For example, an agitator which may be used is one that is provided with a moving vane inside thereof, which rotates at the rate of 40 rpm. The agitator may be provided with a cover in the upper part to be sealed hermetically, and is connected with a decompression device via a hose to keep the pressure of 0 mm to 260 mm Hg inside the agitator. At this point, the stuffing blend may be intubated, preferably under vacuum, into eviscerated lobsters in the chilled or frozen state.

The raw stuffing blend prepared as described above, is introduced into the eviscerated and back-flushed visceral cavity of the lobster, via oral intubation. In this procedure, a metering pump can be utilized, e.g., the one sold by Mari-tech Ltd. (Canada). Dependent upon the size range of the lobster, the amount of stuffing blend which is introduced in the oral cavity will vary. By way of example, the principles of this embodiment of this invention can be applied to lobsters of varying size range, and most commonly weigh between 250 g and 1.5 kg. Such amounts which are required to fill the visceral cavity of lobsters amount to between 10% and 15% of the final weight of the lobster. Following metered filling of the visceral cavity, the lobster is subjected briefly to mechanical vibration, wherein the filled lobster is maintained in a vertical position, with the oral cavity facing uppermost and is subjected to a gentle vibrating force. In this procedure, any residual air pockets which are entrained within the visceral cavity are voided and a complete fill of the cavity is ensured. The final product of this step is an eviscerated stuffed raw intact lobster product. This lobster product is an intact lobster, in which intact lobster meat is loosened but is retained within the intact lobster shell in situ.

According to the present invention, the intact crustacean meat is not subject to visceral staining and/or concentration of heavy metal contaminants. The crustacean product, according to the present invention also includes a stuffing in the visceral cavity, which has attained very intimate entrainment and interface to the internal shell contours and anterior abdominal facet of the loosened crustacean meat. The stuffing is also not subject to any “off-flavours”.

To substantiate the above statements, analyses have been carried out to determine the amount of heavy metal contaminants in a lobster product, as one embodiment of a crustacean. As a comparison, the average cadmium content of lobster product according to the processing of the present invention and according to the processing of the prior art, is as follows:

Comparative Cadmium Data

Average Cadmium Content

| Description | Present Invention | Prior Art |
|---|---|---|
| Meat | 0.006 ppm | 0.19 ppm |
| Tomalley or Filling | Filling | Tomalley |
| | 0.055 ppm | 3.72 ppm |
| Edible portion of the | 0.026 ppm* | 0.26 ppm* |
| lobster product | | |

*Based on 40% of the edible product as filling
** Based on 2% of the edible product as tomalley

For other heavy metals for the lobster product of the present invention, the following tables are a summary:

| Sample | | | Results |
|---|---|---|---|
| Description | Analysis | Units | (x ± U**) |
| Lobster Filling | Cadmium | mg/kg | 0.036 |
| | Chromium | mg/kg | nd |
| | Copper | mg/kg | 11.419 |
| | Manganese | mg/kg | 0.512 |
| | Lead | mg/kg | nd |
| | Zinc | mg/kg | 34.846 |
| Lobster Meat | Cadmium | mg/kg | nd |
| | Chromium | mg/kg | 0.033 |
| | Copper | mg/kg | 4.189 |
| | Manganese | mg/kg | 0.254 |
| | Lead | mg/kg | 0.139 |
| | Zinc | mg/kg | 21.742 |
| Lobster Filling | Cadmium | mg/kg | 0.087 |
| | Chromium | mg/kg | 0.001 |
| | Copper | mg/kg | 11.976 |
| | Manganese | mg/kg | 0.56 |
| | Lead | mg/kg | 0.061 |
| | Zinc | mg/kg | 34.792 |
| Lobster Meat | Cadmium | mg/kg | 0.018 |
| | Chromium | mg/kg | 0.048 |
| | Copper | mg/kg | 5.638 |
| | Manganese | mg/kg | 0.44 |
| | Lead | mg/kg | nd |
| | Zinc | mg/kg | 28.442 |
| Lobster Filling | Cadmium | mg/kg | 0.041 |
| | Chromium | mg/kg | 0.022 |
| | Copper | mg/kg | 12.57 |
| | Manganese | mg/kg | 0.525 |
| | Lead | mg/kg | nd |
| | Zinc | mg/kg | 35.878 |
| Lobster Meat | Cadmium | mg/kg | nd |
| | Chromium | mg/kg | 0.28 |
| | Copper | mg/kg | 5.363 |
| | Manganese | mg/kg | 0.361 |
| | Lead | mg/kg | 0.132 |
| | Zinc | mg/kg | 26.668 |

**The report measurement uncertainty (U) is calculated using 2 as the coverage factor which gives a confidence level of approximately 95%.
Methods used:
1. SOP 901-CMO

Previously, packaging of lobster product processed by the present invention has been described. Among the packaging of lobster product of the prior art which may be used in conjunction with the present invention are the following:

“POPSICLE™ Pack”—Frozen in Brine

The “POPSICLE™ pack comprises a single lobster suspended in a brine-filled plastic sleeve and quickly frozen.

Whole Cooked Bulk Pack Freshly cooked lobster is provided by placing the frozen lobster in boiling water for three minutes.

Whole Cooked Lobster in Netting

A single lobster is cooked and wrapped in netting.

Tail Products

The tail portion of the lobster is glazed with ice, frozen with a blast of CO₂, and packed in two layers separated by a plastic mesh.

“Cold Pack”—Frozen Cans

Cooked lobster meat is packed in a can and blast frozen.

“Hot Pack”—Shelf Stable Cans

Cooked lobster is packed in heat retorted cans and needs no refrigeration.

“VacPack” Vacuum-Sealed Packages

Cooked lobster meat is packed in a plastic sleeve, and the air is quickly evacuated to form a freshness seal.

With the above-described preparative methods of this embodiment of this invention, and with the equipment specifically-designed to support the procedures, up to 400 units per hour of finished lobster products can be processed, which is commercially interesting and appealing.

### (vi) WAY IN WHICH INVENTION IS CAPABLE OF EXPLOITATION IN INDUSTRY

The present invention provides the following procedures which are capable of exploitation in industry.

The invention provides a novel processing procedure of crustaceans; provides a novel procedure which includes a technique which facilitates the loosening and the removal of the edible, intact raw meat from intact shells of crustaceans to be returned later to the intact shell of such crustacean; provides a technique for separating intact raw meat from hard-shelled crustaceans, particularly various species of lobster and crab; and provides a procedure for producing either an intact, whole, such crustacean containing intact adhered or detached crustacean meat, or a stuffed, intact, whole such crustacean containing both intact adhered or detached crustacean meat and stuffing which overcomes problems of the prior art, especially with respect to visceral staining of the crustacean meat and/or the concentration of heavy-metal contaminants in the crustacean meat.

The crustacean product of this invention has proven to have excellent taste and texture characteristics, when served in either the intact form, or as bi-sectioned split halves. The crustacean product can be presented as either chill-thawed or re-warmed, as preferred by consumers. The high-quality appearance of the crustacean product is assured through definition of meat containing no visible intestinal content, nor hepatopancreatic visceral staining. There is also little or no heavy metal contamination.

The crustacean product of this invention serves to meet ever increasingly-stringent requirements by nations for minimum acceptable tolerance levels for certain heavy-metal components.

The stuffed crustacean product of this invention has proven to have excellent taste and texture characteristics, when served in either the intact form, or as bi-sectioned split halves. The stuffed crustacean product can be presented as either chill-thawed or re-warmed, as preferred by consumers. The high-quality appearance of the stuffed crustacean product is assured through definition of meat containing no visible intestinal content, nor hepatopancreatic visceral staining, and a very attractive stuffing, which through the preparative method, is assured of attaining very intimate entrainment and interface to the internal shell contours and anterior abdominal facet of the tail meat, and which is not subject to “off-flavours”. The overall appearance is of a continuum of stuffing-blend and crustacean meat. The stuffed crustacean product of this invention serves to meet ever increasingly-stringent requirements by nations for minimum acceptable tolerance levels for certain heavy-metal components.

Thus, the advantages of the present invention include the following:

There is no significant off colour/odour/flavour.

There is no significant tainting.

The procedure reduces metal contamination in the crustacean meat, if stuffed, in the edible stuffing.

There is reduced leaching of heavy metals into the raw crustacean meat in the fresh/frozen crustacean upon storage.

1. A method for processing a killed crustacean comprising:
cutting the thorax of said killed crustacean;
vacuum eviscerating the anterior section of said crustacean through said cut thorax;
completing the removal of the contents of the anterior section of the crustacean by the sole step of back flushing the anterior section of the crustacean with water;
vacuum eviscerating the posterior section of said crustacean;
completing the removal of the posterior visceral and intestinal contents of said crustacean by the sole step of back-flushing said posterior section of said crustacean with water;
thereby providing:
an intact crustacean having intact raw edible crustacean mean in situ, in which said intact raw edible crustacean meat is not subject to visceral staining and/or the concentration of heavy-metal contaminants therein.

2. The method of claim 1 further comprising the steps of:
initiating the detachment of intact raw edible crustacean meat from an intact shell of said crustacean by the step of subjecting said intact shell to at least one freeze-thaw cycle; retaining said intact detached raw edible crustacean meat in situ within said intact shell;
wherein the intact crustacean has intact detached raw edible crustacean meat in situ, in which said intact detached raw edible crustacean meat is not subject to visceral staining and/or the concentration of heavy-metal contaminants therein.

3. A method for processing a killed crustacean comprising:
cutting the thorax of said killed crustacean;
vacuum eviscerating the anterior section of said crustacean through said cut thorax;
completing the removal of the contents of the anterior section of the crustacean by the sole step of back flushing the anterior section of the crustacean with water;
vacuum eviscerating the posterior section of said crustacean;
completing the removal of the posterior visceral and intestinal contents of said crustacean by the sole step of back-flushing said posterior section of said crustacean; and
filling said anterior visceral cavity of said crustacean with a stuffing;
thereby providing:
an intact stuffed crustacean having intact adhered raw edible crustacean meat in situ which is in contact with said stuffing within said crustacean shell, said intact adhered raw edible crustacean meat and said stuffing not being subject to visceral staining and/or the concentration of heavy-metal contaminants therein.

4. A method for processing a killed crustacean comprising:
cutting the thorax of said killed crustacean;
vacuum eviscerating the anterior section of said crustacean through said cut thorax;
completing the removal of the contents of the anterior section of the crustacean by the sole step of back flushing the anterior section of the crustacean with water;
vacuum eviscerating the posterior section of said crustacean;
completing the removal of the posterior visceral and intestinal contents of said crustacean by the sole step of back-flushing said posterior section of said crustacean with water;
initiating the detachment of intact raw edible crustacean meat from an intact shell of said crustacean by the step of subjecting said intact shell to at least one freeze-thaw cycle;
retaining said intact detached raw edible crustacean meat in situ within said intact shell; and
filling said interior visceral cavity of said crustacean with a stuffing;
thereby providing:
an intact stuffed crustacean having intact detached raw edible crustacean meant in situ which is in contact with said stuffing within said crustacean shell, said intact detached raw edible crustacean meat and said stuffing not being subject to visceral staining and/or the concentration of heavy-metal contaminants therein.

5. The method of claim 1, including the steps of stuffing the thorax cavity with a stuffing blend; cooking said stuffed thorax; and packaging said cooked stuffed thorax by freezing and glazing said cooked stuffed thorax.

6. The method of claim 1, including the steps of stuffing the thorax cavity with a stuffing blend; cooking said stuffed thorax; and packaging said cooked stuffed thorax by chilling said fresh cooked thorax.

7. The method of claim 1, including the steps of: stuffing the thorax cavity with a stuffing blend; freezing said stuffed thorax; and packaging and glazing said frozen stuffed blend.

8. The method of claim 1, including the steps of: freezing said intact vacuum eviscerated and back-flushed irrigated lobster, packaging said frozen lobster; and glazing said packaged lobster.

9. The method of claim 1, including the step of mastering and storing said lobster product.

10. The method of claim 1, wherein said vacuum eviscerating is achieved under 50.84×10⁴ dynes/cm² to 85.75×10⁴ dynes/cm².

11. The method of claim 1, wherein said back-flushing is with a dilute aqueous solution of lactic acid, thereby to provide bacteriostatic properties to said eviscerated crustacean.

12. The method of claim 11, wherein said lactic acid is at a concentration of 5 to 20 ml/L (w/w).

13. The method of claim 1, wherein said crustacean has been killed by blanching at a temperature of 70° C. to 100° C. for a time, respectively, of 60 seconds to 40 seconds.

14. The method of claim 1, wherein said intact crustacean containing said intact adhered or detached raw crustacean meat, is frozen and then packaged.

15. The method of claim 1, wherein said intact crustacean containing said intact raw adhered or detached raw crustacean meat, is chilled.

16. The method of claim 1, including the steps of:
cooking said intact, whole crustacean containing intact adhered or detached raw crustacean meat, at 100° C., for a sufficient period of time to achieve an internal temperature of at least 75° C.; and rapid cooling to effect rapid temperature removal.

17. The method of claim 16, wherein said cooking step is by steam-cooking.

18. The method of claim 16, wherein said cooling step is by spray irrigation.

19. The method of claim 16, wherein said crustacean containing said intact adhered or detached cooked crustacean meat, is frozen and then packaged.

20. The method of claim 16, wherein said crustacean containing said intact adhered or detached cooked crustacean meat, is chilled and then packaged.

21. The method of claim 16, wherein a raw stuffing is introduced into an interior visceral cavity of a previously-eviscerated crustacean by oral intubation and subsequent vibration to effect removal of residual air;
thereby to achieve effective filling of the interior visceral cavity and effecting integuous contact between the raw stuffing and the contour of the inner shell surface and the region of abutment of the internal and interior abdominal facets of the meat of the previously-eviscerated crustacean.

22. The method of claim 21, wherein said stuffed crustacean containing said intact adhered or detached cooked crustacean meat, and said cooked stuffing is frozen and then packaged.

23. The method of claim 21, wherein said stuffed crustacean containing said intact adhered or detached cooked crustacean meat, and said cooked stuffing is chilled and then packaged.

24. A method of processing live crustacean comprising
killing said crustacean by subjecting said crustacean to at least one freeze/thaw cycle;
removing the tail, the claws and knuckles from the body with legs, cap and lower body of said crustacean; and
subjecting said claws/knuckles, said tail and said bodies with legs, cap and lower body to further processing.

25. The method of claim 24, including the steps of removing the shell from the meat of the claws and knuckles, and individually or collectively packaging said claws and knuckle meat for sale as fresh or frozen crustacean meat.

26. The method of claim 24, including the steps of removing the shell from the meat of the tail and individually or collectively packaging said claws and knuckle meat for sale as fresh or frozen crustacean meat.

27. The method of claim 24, including the steps of removing the cap and cutting away the legs from the bodies with legs, cap and body; discarding the cap; cooking the legs; rolling the crustacean meat from the cooked legs; packing the leg meat; and freezing the packed leg meat.

28. The method of claim 24, including the steps of removing the gills from the bodies without the cap and legs; separating the raw crustacean body meat from said body with a meat separator; packing said body meat; and freezing said packed body meat.

29. The method of claim 24, wherein said freezing is carried out at a temperature of 10° C. to minus 20° C., followed by thawing until a temperature of 4° C. to minus 12° C. is reached.

30. The method of claim 24, wherein said thawing is accomplished in cold water, or in a cold dilute solution of brine.

31. The method of claim 30, wherein said thawing is accomplished at a temperature of 1° C. to 10° C. for a period of time between 11 minute and 10 minutes.

32. The method as claimed in claim 31, wherein said thawing is accomplished in a period of time of 3 minutes to 8 minutes.

33. The method of claim 1, wherein said crustacean is Homaridae lobster.

34. The method of any one of claim 1, wherein said crustacean is Spiny lobster.

35. The method of claim 1, wherein said crustacean is Lithodes maja, or Neolithodes grimaldii, or Cancer pagurus, or Cancer borealis crab.

36. An intact crustacean in which the intact, adhered or detached raw crustacean meat is retained in the shell of said crustacean in situ, the visceral and intestinal contents of said crustacean having been partially removed by vacuum evisceration and the visceral and intestinal contents of said crustacean have then been substantially-completely removed by the sole step of back flushing with water, said intact adhered or detached raw crustacean meat thereby not being subject to visceral staining and/or the concentration of heavy-metal contaminants therein.

37. An intact crustacean in which intact adhered or detached raw crustacean meat is retained in the shell of said crustacean in situ, the visceral and intestinal contents of said crustacean having been partially removed by vacuum evisceration and the visceral and intestinal contents of said crustacean have then been substantially-completely removed by the sole step of back flushing with water, said eviscerated crustacean having a filling therein in contact with said intact adhered or detached raw crustacean meat, and with the interior of said shell of said crustacean;
said intact raw adhered or detached crustacean meat thereby not being subject to visceral staining and/or the concentration of heavy-metal contaminants therein, and said stuffing thereby not having any “off-flavour”.

38. (canceled)

39. (canceled)

40. (canceled)
